(19) United States
(12) Patent Application Publication
(10) Pub. No.: US 2005/0068627 A1
(43) Pub. Date: Mar. 31, 2005

(54) Tunable optical filter and method of manufacturing same

(76) Inventors: Ryosuke Nakamura, Chino-shi (JP); Shinichi Kamisuki, Shiojiri-shi (JP); Akihiro Murata, Hokuto-shi (JP); Mitsuhiro Yoda, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/915,122

(22) Filed: Aug. 10, 2004

(30) Foreign Application Priority Data
Aug. 11, 2003 (JP) 2003-291165

(51) Int. Cl. G02B 27/00

(52) U.S. Cl. 359/578; 359/223

(57) ABSTRACT

A tunable optical filter is provided by joining a movable unit that supports a movable body moving up and down freely, and whose top surface has a highly reflective film formed thereon, a drive electrode unit in which a drive electrode facing the movable body with an electrostatic gap EG therebetween is formed, and an optical gap unit in which a highly reflective film facing the highly reflective film with an optical gap OG therebetween is formed.

### RELATED APPLICATIONS

This application claims priority to Japanese Patent Application No. 2003-291165 filed Aug. 11, 2003 which is hereby expressly incorporated by reference herein in its entirety.

### BACKGROUND

The present invention relates to a tunable optical filter that transmits light wavelength-selectively in order to extract a light component having a desired wavelength among a plurality of light components transmitted in an optical fiber and having different wavelengths in a wavelength division multiplexing (WDM) optical communication network and so on, and a method of manufacturing the same.

A conventional tunable optical filter utilizes the principle of a Fabry-Perot interferometer, and comprises a fixed mirror formed on a substrate and a movable mirror opposed to the fixed mirror in such a manner that an electrostatic gap is formed between the fixed and movable mirrors. In the tunable optical filter, drive voltage is applied between a movable electrode provided for the movable mirror and a fixed electrode provided for the fixed mirror so as to displace the movable mirror with respect to the fixed mirror, and thereby the length of the electrostatic gap can be varied. This electrostatic gap is formed by initially providing a sacrificial layer of given shape and size between the fixed mirror and movable mirror by utilizing a micro machining technique, and thereafter removing all or part of the sacrificial layer by etching (for example, refer to Japanese Unexamined Patent Publication No. 2002-174721 (claim 9, [0005], [0018], [0037], [0049]-[0056], and FIG. 6)). This art will be referred to as a first related art hereinafter.

In some conventional tunable optical filters, the electrostatic gap is formed using a silicon dioxide (SiO₂) layer of an SOI (Silicon on Insulator) wafer as a sacrificial layer (for example, refer to U.S. Pat. No. 6,341,039 (Sixth-Seventh column, and FIGS. 4A-4I)). This art will be referred to as a second related art hereinafter.

In a tunable optical filter, drive voltage is applied to a parallel plate capacitor that is formed between a movable electrode provided for a movable mirror and a fixed electrode provided for a fixed mirror so as to generate electrostatic attraction between the movable and fixed mirrors, and thereby the movable mirror is displaced with respect to the fixed mirror. Here, in the case of applying drive voltage V to a parallel plate capacitor in which two pole plates of area S and distance d are opposed to each other with a dielectric of a dielectric constant ε therebetween, electrostatic attraction F, which acts on two pole plates, is represented by formula (1), as is well known.
F=(1/2)·ε·(V/d)²·S (1)

In the first related art, the length of the electrostatic gap corresponding to the distance d is determined only based on the film thickness of a sacrificial layer. Even if a film-forming condition when manufacturing is set strictly, however, there may be a concern that a variation in the film thickness of sacrificial layers is caused. In the case where the variation is caused, even if the given drive voltage V is applied between the movable and drive electrodes, electrostatic attraction F that was expected by design for the drive voltage V can not be generated such that the movable mirror can not be displaced as designed. As a result, there has been a problem that, since the drive voltage for extracting a light component having each wavelength needs to be controlled and set for each tunable optical filter, the usability is not good. In addition, in the case where variation in the film thickness of the sacrificial layer is large, there may be a concern that a tunable optical filter that can not extract a light of a short-wavelength band or a light of a long-wavelength band among a plurality of light components transmitted in an optical fiber and having different wavelengths, is manufactured.

Meanwhile, in the second related art, since a movable mirror is not insulated from a drive electrode, there may be a case where, in the case where a large drive voltage is applied between a movable electrode and a drive electrode for any reason, a phenomenon referred to as sticking in which the movable mirror sticks to the drive electrode due to electrostatic attraction is caused and the movable mirror releases from the drive electrode even if the drive voltage is removed. In this case, the tunable optical filter can not be used from then on.

Furthermore, in either the first or second related arts, the sacrificial layer that has been formed is finally removed. In order to completely remove the sacrificial layer completely, usually, in a movable mirror, a movable electrode, and so on, a hole is formed on a top surface of the sacrificial layer, which is referred to as a release hole, for spreading an etchant that wet-etches the sacrificial layer across the entire area where the sacrificial layer is formed. Accordingly, since the area of the movable electrode decreases for the forming area of the release hole, the drive voltage V needs to be increased in order to generate a given electrostatic attraction F, as is apparent from the above formula (1), such that power consumption increases correspondingly. In addition, in either the first or second related arts, in the case where the length of the electrostatic gap is short, sticking attributed to the surface tension of water is caused when the sacrificial layer is removed. A tunable optical filter in which sticking is caused becomes a defective product.

The present invention is devised in order to solve such problems, and is intended to obtain a tunable optical filter whose electrostatic gap can be formed precisely, that can be driven with low drive voltage, and where sticking during manufacturing and while in use can be avoided, and a method of manufacturing the same.

### SUMMARY

In a tunable optical filter according to one aspect of the invention, a movable unit supporting a movable body that moves up and down freely and whose one surface has a movable mirror formed thereon, a drive electrode unit in which a drive electrode facing the movable body with a given electrostatic gap therebetween is formed, and an optical gap unit in which a fixed mirror facing the movable mirror with a given optical gap therebetween is formed, are joined to each other.

According to the invention, an electrostatic gap is formed precisely while a release hole is not formed in the movable body such that the tunable optical filter can be driven with low drive voltage.

In the tunable optical filter according to another aspect of the invention, an insulating film is formed on at least one of an area of the drive electrode that faces the movable body, and an area of the movable body that faces the drive electrode.

This enables sticking during manufacturing and while in use to be avoided.

In the tunable optical filter according to another aspect of the invention, an antireflection film formed on the other surface of the movable body is also used as the insulating film.

This enables the tunable optical filter to be constituted through less manufacturing processes at low cost.

In the tunable optical filter according to another aspect of the invention, the movable unit is composed of silicon. At least one of the drive electrode unit and the optical gap unit are composed of glass containing an alkali metal. At least one of the joining between the movable unit and the drive electrode unit, and the joining between the movable unit and the optical gap unit is implemented by anodic bonding.

According to the invention, an electrostatic gap is formed with extremely high precision. Accordingly, if a given drive voltage is applied between the movable body and the drive electrode, electrostatic attraction that was expected by design for the drive voltage can be generated such that the movable body can be displaced as designed. As a result, there is no need to control and set the drive voltage for extracting light components having each wavelength, for each tunable optical filter. Thus the usability is excellent, and all light components transmitted in an optical fiber that have different wavelengths can be extracted.

In a method of manufacturing a tunable optical filter according to another aspect of the invention, a first concave portion is formed in a first substrate, and then a drive electrode is formed on the first concave portion so as to form a drive electrode unit, in a first step. In addition, in a second step, a second concave portion is formed in a second substrate, and then a fixed mirror is formed on the second concave portion so as to form an optical gap unit. Next, in a third step, a third substrate on which an active layer having electrical conductivity, an insulating layer, and a base layer are sequentially deposited, is joined to the drive electrode unit in such a manner that the drive electrode faces the active layer, and then the base layer and the insulating layer are removed sequentially and a movable body is formed in the active layer, and thereafter a movable mirror is formed on the movable body. Then, in a fourth step, a structure that has been manufactured in the third step is joined to the optical gap unit in such a manner that the movable mirror faces the fixed mirror so as to manufacture the tunable optical filter.

According to the invention, a gap between the drive electrode and the movable body is formed without forming a sacrificial layer. Accordingly, a release hole for removing the sacrificial layer need not be formed in the movable body and so on such that the movable body having the area as designed can be obtained. Thus a manufactured tunable optical filter can be driven with a low drive voltage such that power consumption can be reduced.

In a method of manufacturing a tunable optical filter according to another aspect of the invention, a first concave portion is formed in a first substrate, and then a drive electrode is formed on the first concave portion so as to form a drive electrode unit, in a first step. In addition, in a second step, a second concave portion is formed in a second substrate, and then a fixed mirror is formed on the second concave portion so as to form an optical gap unit. Next, in a third step, a third substrate on which an active layer having electrical conductivity on which a movable mirror is formed, an insulating layer, and a base layer are sequentially deposited, is joined to the optical gap unit in such a manner that the movable mirror faces the fixed mirror, and then the base layer and the insulating layer are removed sequentially and a movable body is formed in the active layer. Then, in a fourth step, a structure that has been manufactured in the third step is joined to the drive electrode unit in such a manner that the movable body faces the drive electrode.

According to the invention, a gap between the drive electrode and the movable body is formed without forming a sacrificial layer. Accordingly, a release hole for removing the sacrificial layer need not be formed in the movable body and so on such that the movable body having the area as designed can be obtained. Thus a manufactured tunable optical filter can be driven with a low drive voltage such that power consumption can be reduced.

In the method of manufacturing a tunable optical filter according to another aspect of the invention, an insulating film is formed on an area to face the movable body of the drive electrode, in the first step.

Furthermore, in the method of manufacturing a tunable optical filter according to another aspect of the invention, the joining is implemented in such a manner that the drive electrode faces the active layer after an insulating film is formed on an area to face the drive electrode as the movable body of the active layer, in the third step.

Moreover, in the method of manufacturing a tunable optical filter according to another aspect of the invention, an insulating film is formed on an area to become the movable body and face the drive electrode before the movable body is formed, in the third step.

According to the invention, sticking during manufacturing and while in use can be avoided.

In the method of manufacturing a tunable optical filter according to another aspect of the invention, the insulating film and an antireflection film are formed on an area to become the movable body of the active layer, in the third step.

Furthermore, in the method of manufacturing a tunable optical filter according to another aspect of the invention, the insulating film and an antireflection film are formed on an area to become the movable body before the movable body is formed, in the third step.

According to the invention, sticking during manufacturing and while in use can be avoided while a tunable optical filter can be constituted through less manufacturing processes at low cost.

In the method of manufacturing a tunable optical filter according to another aspect of the invention, the active layer is composed of silicon. At least one of the first substrate and the second substrate are composed of glass containing an alkali metal. The joining is implemented by anodic bonding in at least one of the third step and the fourth step.

According to the invention, an electrostatic gap is formed with extremely high precision. Accordingly, if a certain drive voltage is applied between the movable body and the drive electrode, electrostatic attraction that was expected by design for the drive voltage can be generated such that the movable body can be displaced as designed. As a result, there is no need to control and set the drive voltage for extracting light components having each wavelength, for each tunable optical filter. Thus the usability is excellent, and all light components transmitted in an optical fiber that have different wavelengths can be extracted.

### BRIEF DESCRIPTION OF THE DRAWINGS

FIG. 1 is a sectional view of a tunable optical filter that shows an embodiment of the present invention.

FIG. 2 is a top view of a movable unit substrate constituting the tunable optical filter.

FIGS. 3(1)-3(6) are diagrams showing a manufacturing process of the tunable optical filter.

FIGS. 4(1)-4(2) are diagrams showing a manufacturing process of the tunable optical filter.

FIGS. 5(1)-5(2) are diagrams showing a manufacturing process of the tunable optical filter.

FIG. 6 is a diagram showing a manufacturing process of the tunable optical filter.

FIGS. 7(1)-7(4) are diagrams showing a manufacturing process of the tunable optical filter.

FIGS. 8(1)-8(6) are diagrams showing a manufacturing process of the tunable optical filter.

### DETAILED DESCRIPTION

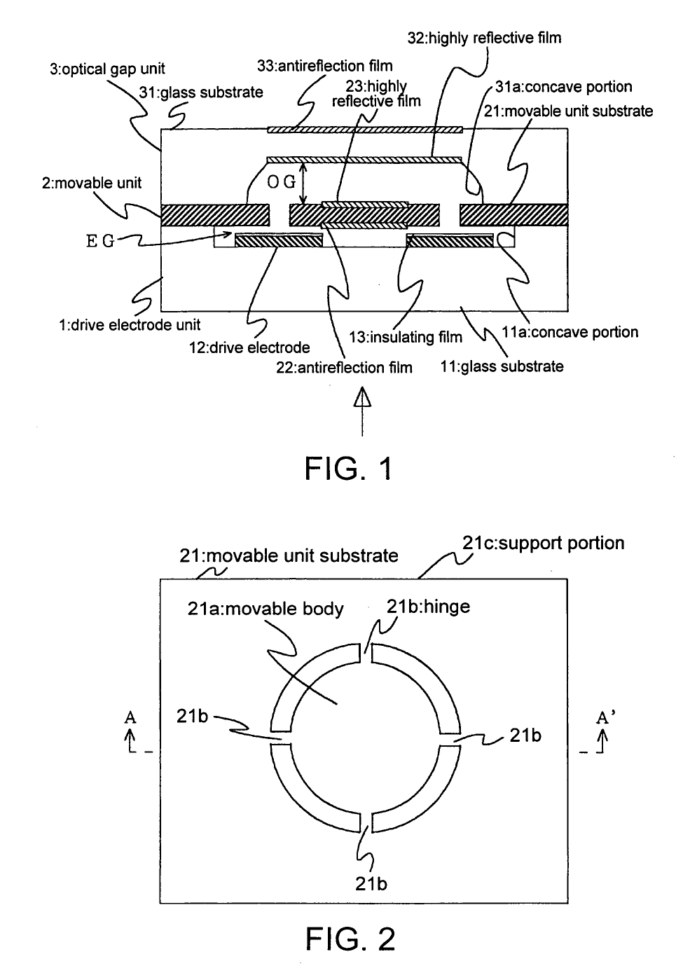

FIG. 1 is a sectional view showing a tunable optical filter according to an embodiment of the present invention. Here, FIG. 1 is a sectional view for a position slightly deviated from the center of the tunable optical filter (refer to A-A′ of FIG. 2).

The tunable optical filter of the embodiment comprises a drive electrode unit 1, a movable unit 2, and an optical gap unit 3. An electrostatic gap EG whose length is about 4 micrometers is formed between the drive electrode unit 1 and the movable unit 2. An optical gap OG whose length is about 30 micrometers is formed between the movable unit 2 and the optical gap unit 3. The drive electrode unit 1 is constituted by forming a drive electrode 12 and an insulating film 13 that have a substantially ring shape, on a concave portion 11a formed in a substantially center part of a glass substrate 11 whose section has a substantially U-shape. The glass substrate 11 is composed of glass containing alkali metal such as sodium (Na) and potassium (K) for example. As glass of this kind, for example, borosilicate glass containing an alkali metal, specifically, Pyrex (registered trademark)•glass from Corning Co. is named. In the case of joining the drive electrode unit 1 to the movable unit 2 by anodic bonding (to be described later), glass constituting the glass substrate 11 is required to have almost same coefficient of thermal expansion as that of silicon constituting the movable unit 2 since the glass substrate 11 is heated. Thus, among the Pyrex (registered trademark)•glass, Corning #7740 (brand name) is preferable.

The drive electrode 12 is composed of metal such as gold (Au) and chromium (Cr), or a transparent conductive material for example. As transparent conductive materials, for example, there are tin oxide (SnO₂), indium oxide (In₂O₃), and indium tin oxide (ITO). The film thickness of the drive electrode 12 is 0.1-0.2 micrometers for example. The drive electrode 12 is coupled to a terminal provided outside the glass substrate 11 with wiring therebetween, although not shown in the drawing. The insulating film 13 is composed of silicon dioxide (SiO₂) or silicon nitride (SiNₓ) for example, and is formed in order to prevent sticking between the drive electrode 12 and a movable body 21a to be described later.

The movable unit 2 comprises a movable unit substrate 21, an antireflection film 22, and a highly reflective film 23. The movable unit substrate 21 is composed of silicon dioxide (SiO₂) for example, and has a film thickness of about 4 micrometers. As shown in FIG. 2, the movable body 21a, 4 (four) hinges 21b, and a support portion 21c are formed monolithically so as to constitute the movable unit substrate 21. The movable body 21a has a substantially disk shape, and is formed on substantially the center of the movable unit substrate 21. The movable body 21a is supported by the support portion 21c with the 4 (four) hinges 21b formed in a peripheral portion of the movable body 21, and moves up and down freely. The 4 (four) hinges 21b are disposed in the periphery of the movable body 21a in such a manner that the adjacent hinges form an angle of about 90 degrees with each other.

The antireflection film 22 is formed on almost the entire area of lower surface of the movable body 21a, and is formed of a multi-layered film in which silicon dioxide (SiO₂) thin films and tantalum pentoxide (Ta₂O₅) thin films are deposited alternately. The antireflection film 22 prevents light incident from below at generally the center of the drive electrode unit 1 (refer to the arrowhead of FIG. 1) in FIG. 1 from being reflected downwardly in the drawing, while the antireflection film 22 prevents light reflected by the highly reflective film 23 after being transmitted to above the antireflection film 22 from being reflected upwardly in the drawing. The highly reflective film 23 is formed on almost the entire area of a top surface of the movable body 21a, into a substantially disc shape, and is formed of a multi-layered film in which silicon dioxide (SiO₂) thin films and tantalum pentoxide (Ta₂O₅) thin films are deposited alternately. The highly reflective film 23 is an element for reflecting light incident from below at substantially the center of the drive electrode unit 1 (refer to the arrowhead of FIG. 1) in FIG. 1 that has been transmitted to above the highly reflective film 23, multiple times between the highly reflective film 23 and a highly reflective film 32 formed on a lower surface of a glass substrate 31 constituting the optical gap unit 3. The antireflection film 22 and the highly reflective film 23 are formed by changing each film thickness of a silicon dioxide (SiO₂) thin film and a tantalum pentoxide (Ta₂O₅) thin film.

The optical gap unit 3 comprises the glass substrate 31, the highly reflective film 32, and an antireflection film 33. The glass substrate 31 is composed of glass whose material is same as that of the glass substrate 11, and the section thereof has a substantially doubly-supported-beam shape in which a concave portion 31a is formed in a substantially center part thereof. The highly reflective film 32 is formed on a lower surface of the concave portion 31a of the optical gap unit 3, into a substantially disc shape, and is formed of a multi-layered film in which silicon dioxide (SiO₂) thin films and tantalum pentoxide (Ta₂O₅) thin films are deposited alternately. The highly reflective film 32 is an element for reflecting light incident from below at substantially the center of the movable unit 2 in FIG. 1 that has been transmitted to above the movable unit 2, multiple times between the highly reflective film 32 and the highly reflective film 23 constituting the movable unit 2. The antireflection film 33 is formed on a top surface at generally the center of the optical gap unit 3, into a substantially disc shape, and is formed of a multi-layered film in which silicon dioxide (SiO₂) thin films and tantalum pentoxide (Ta₂O₅) thin films are deposited alternately. The antireflection film 33 prevents light transmitted through the glass substrate 31 constituting the optical gap unit 3 in FIG. 1 from being reflected downwardly in the drawing. The highly reflective film 32 and the antireflection film 33 are formed by changing each film thickness of a silicon dioxide (SiO₂) thin film and a tantalum pentoxide (Ta₂O₅) thin film.

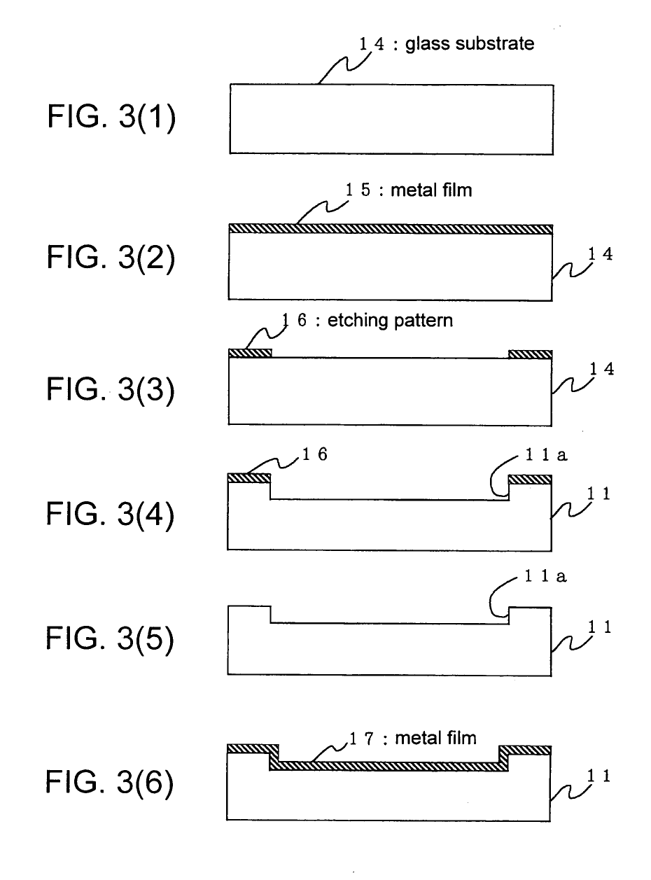

Next, a method of manufacturing a tunable optical filter having the above structure will be described referring to FIGS. 3 through 8. First, in order to fabricate the drive electrode unit 1, on a top surface of a glass substrate 14 (refer to FIG. 3(1)) composed of, for example, Corning #7740 of Pyrex (registered trademark) glass, a metal film 15 such as gold (Au) and chromium (Cr) is formed by using a chemical vapor deposition (CVD) device or physical vapor deposition (PVD) device as shown in FIG. 3(2). As PVD devices, for example, a sputtering device, a vacuum deposition device, an ion plating device, and soon are listed. The film thickness of the metal film 15 is 0.1 micrometers for example. Specifically, in the case of a chromium (Cr) film, the film thickness may be 0.1 micrometers. In the case of a gold (Au) film, since contact of gold with the glass substrate 14 is not good, a gold (Au) film whose film thickness is 0.07 micrometers for example is formed after a chromium (Cr) film whose film thickness is 0.03 micrometers for example is formed.

Next, the entire top surface of the metal film 15 is coated with photo resist (not shown in the drawing) and then the photo resist applied to the entire top surface of the metal film 15 is exposed using a mask aligner. Thereafter, by using a photolithography technique, in which developing is implemented using a developer, a photo resist pattern (not shown in the drawing) is formed in order to later form a portion to become the concave portion 11a (refer to FIG. 1) of the glass substrate 11 from the glass substrate 14. Then, by using a wet-etching technique, an unnecessary portion of the metal film 15 is removed with, for example, a hydrochloric acid or a sulfuric acid (in the case of a chromium film), or aqua regia or a solution including a cyanide ion under the presence of oxygen or water (in the case of a gold film) (it is referred to as a metal etchant hereinafter), and thereafter the photo resist pattern (not illustrated) is removed so as to obtain an etching pattern 16 shown in FIG. 3(3).

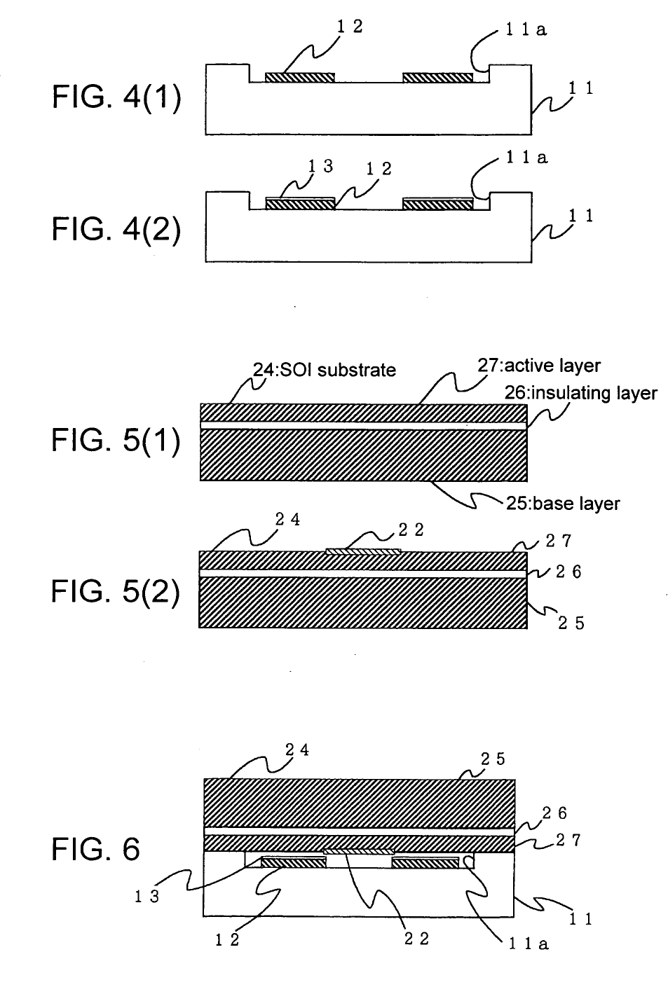

Next, by using a wet-etching technique, an unnecessary portion of the glass substrate 14 is removed with a hydrofluoric acid (HF) for example, so as to form the concave portion 11a shown in FIG. 3(4). Thereafter, by using a wet-etching technique, the etching pattern 16 is removed with the metal etchant, so as to obtain the glass substrate 11 in which the concave portion 11a having the depth of about 4 micrometers is formed as shown in FIG. 3(5). Then, a metal film 17 such as gold (Au) and chromium (Cr) is formed on a top surface of the glass substrate 11 by using a CVD device and a PVD device as shown in FIG. 3(6). The film thickness of the metal film 17 is 0.1-0.2 micrometers for example. Then, after the entire top surface of the metal film 17 is coated with photo resist (not shown in the drawing), a photo resist pattern (not shown in the drawing) is formed by using the photolithography technique in order to leave a portion to become the drive electrode 12 later out of the metal film 17. Next, by using a wet-etching technique, an unnecessary portion of the metal film 17 is removed with the metal etchant, and thereafter the photo resist pattern (not illustrated) is removed so as to obtain the drive electrode 12 as shown in FIG. 4(1). Then, as shown in FIG. 4(2), the insulating film 13 composed of, for example, silicon dioxide (SiO₂) or silicon nitride (SiNₓ) is formed on the drive electrode 12 by using a CVD device. Through the manufacturing processes described above, the drive electrode unit 1 shown in FIG. 1 is manufactured.

Next, in order to fabricate the movable unit 2, an SOI substrate 24 shown in FIG. 5(1) is used. The SOI substrate 24 comprises a base layer 25, an insulating layer 26, and an active layer 27. The base layer 25 is composed of silicon (Si) and has a film thickness of 500 micrometers for example. The insulating layer 26 is composed of silicon dioxide (SiO₂) and has a film thickness of 4 micrometers for example. The active layer 27 is composed of silicon (Si) and has a film thickness of 10 micrometers for example. Silicon dioxide (SiO₂) thin films and tantalum pentoxide (Ta₂O₅) thin films, of about 10-20 layers for example, are deposited alternately using a CVD device and a PVD device, on a top surface at substantially the center of the active layer 27, and thereby the antireflection film 22 shown in FIG. 5(2) is formed.

Next, the drive electrode unit 1 shown in FIG. 4(2) is joined to the SOI substrate 24 shown in FIG. 5(2) on which the antireflection film 22 is formed in such a manner that the antireflection film 22 of a substantially disc shape faces a ring portion of the drive electrode 12 of a substantially ring shape. For this joining, for example, anodic bonding, joining with an adhesive, surface activated bonding, or joining using low melting point glass is used. Among these, anodic bonding is implemented through the following processes. First, at a state where the SOI substrate 24 on which the antireflection film 22 is formed is disposed on a top surface of the drive electrode unit 1 so that the antireflection film 22 faces a ring portion of the drive electrode 12, a negative terminal of a DC power supply not shown in the drawing is coupled to the glass substrate 11, while a positive terminal of the DC power supply is coupled to the active layer 27. Next, while heating the glass substrate 11 at about several hundred degrees centigrade for example, DC voltage of about several hundred V, for example, is applied between the glass substrate 11 and the active layer 27. By heating the glass substrate 11, it becomes easier for a positive ion of an alkali metal in the glass substrate 11a, for example a sodium ion (Na⁺), to move. Since the positive ion of the alkali metal moves in the glass substrate 11, relatively, the bonded surface in the glass substrate 11 with the active layer 27 is negatively charged, meanwhile the bonded surface in the active layer 27 with the glass substrate 11 is positively charged. As a result, the glass substrate 11 is bonded to the active layer 27 tightly as shown in FIG. 6, by covalent bonding in which silicon (Si) and oxygen (O) share an electron pair.

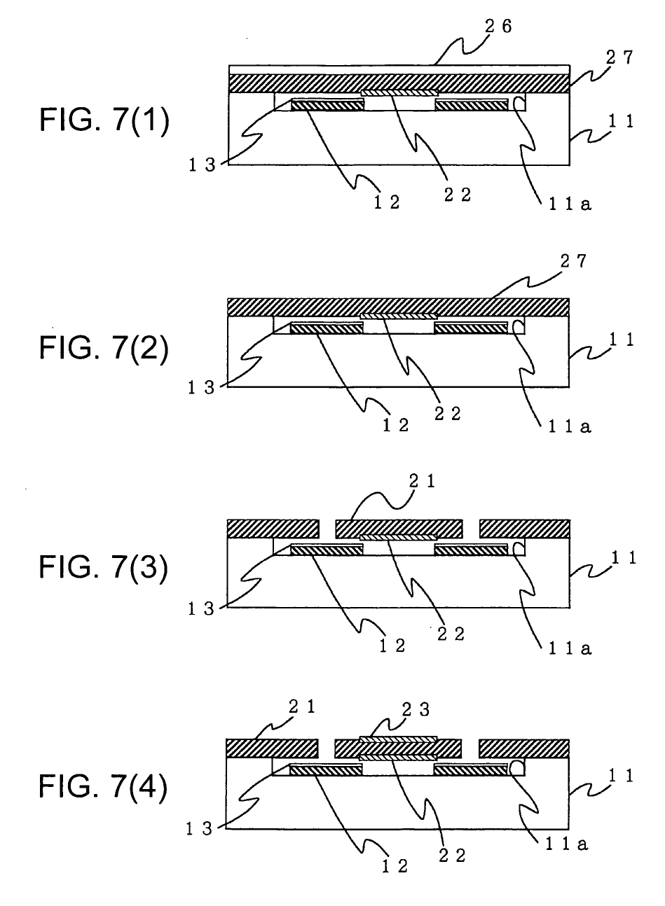

Next, the base layer 25 is removed from the structure shown in FIG. 6, and thereby it becomes the structure shown in FIG. 7(1). For removing of the base layer 25, wet-etching, dry-etching, or polishing is used. In any removing method, since the insulating layer 26 functions as an etchant stopper for the active layer 27, the active layer 27 facing the drive electrode 12 does not suffer from damage such that a tunable optical filter whose process yield is high can be manufactured. A wet-etching removing method and dry-etching removing method will be described below. With respect to a polishing removing method, the description thereof will be omitted since a well-known polishing removing method that is used in a semiconductor manufacturing filed can be used.

(1) Wet-Etching Removing Method

By immersing the structure shown in FIG. 6 in a water solution of potassium hydroxide (KOH) of concentration of 1-40 wt. % (preferably, about 10 wt. %), silicon (Si) constituting the base layer 25 is etched based on a reaction formula shown by formula (2).
Si+2KOH+H₂O→K₂SiO₃+2H₂ (2)

In this case, since the etching rate of silicon (Si) is much larger than that of silicon dioxide (SiO₂), the insulating layer 26 composed of silicon dioxide (SiO₂) functions as an etchant stopper for the active layer 27 composed of silicon (Si).

As etchants used in this case, other than the above water solution of potassium hydroxide (KOH), a water solution of tetramethyl ammonium hydroxide (TMAH), which is widely used as a semiconductor surface treating agent and a developer for positive resist for photolithography, a water solution of ethylenediamine pyrocatechol diazine (EPD), a water solution of hydrazine, and so on, are listed.

Using this wet-etching removing method enables batch treatment in which a group of the structures shown in FIG. 6 is treated as a group with substantially equalizing product conditions and so on thereof to each other such that productivity can be enhanced.

(2) Dry-Etching Removing Method

The structure shown in FIG. 6 is disposed in a chamber of a dry-etching device and then the device is evacuated to a vacuum state. Thereafter, by introducing xenon difluoride (XeF₂) of pressure of 390 Pa, for example, into the chamber for about 60 seconds, silicon (Si) constituting the base layer 25 is etched based on a reaction formula shown by formula (3).
2XeF₂+Si→2Xe+SiF₄ (3)

In this case, since the etching rate of silicon (Si) is much larger than that of silicon dioxide (SiO₂), the insulating layer 26 composed of silicon dioxide (SiO₂) functions as an etchant stopper for the active layer 27 composed of silicon (Si). Since the dry-etching in this case is not plasma-etching, the glass substrate 11 and the insulating layer 26 are less likely to be damaged. Other than dry-etching using the xenon difluoride (XeF₂), there is plasma-etching using carbon tetrafluoride (CF₄) or sulfur hexafluoride (SF₆), for example,.

Next, by using a wet-etching technique, for the structure shown in FIG. 7(1), the insulating layer 26 is all removed with hydrofluoric acid (HF) for example, as shown in FIG. 7(2). Then, after the entire top surface of the active layer 27 is coated with photo resist (not shown in the drawing), a photo resist pattern (not shown in the drawing) is formed by using the photolithography technique in order to leave a portion to become the movable unit substrate 21 later out of the active layer 27. Next, the structure shown in FIG. 7(2) on which a photo resist pattern (not illustrated) is formed is disposed in a chamber of a dry-etching device. Thereafter, by alternately introducing sulfur hexafluoride (SF₆) as an etching gas at flow rate of, for example, 130 sccm for 6 seconds, and cyclobutane octafluoride (C₄F₈) as a deposition gas at flow rate of, for example, 50 sccm for 7 seconds into a chamber, an unnecessary portion of the active layer 27 is removed by anisotropic etching. It is for the following reason that anisotropic etching is implemented using a dry-etching technique. First, in the case of using a wet-etching technique, an etchant penetrates from a hole formed in the movable unit substrate 21 into a lower lying drive electrode unit 1 side as etching advances, so as to remove the drive electrode 12 and the insulating film 13. In the case of using a dry-etching technique, however, such a danger does not exist. Meanwhile, in the case of using isotropic etching, the active layer 27 is etched isotropically so as to cause side etching. In the case where side etching is caused in the hinge 21b especially, the strength thereof becomes weak such that the endurance thereof deteriorates. On the contrary, in the case of using anisotropic etching, side etching is not caused such that there is superiority in controlling etching dimension, and the side surface of the hinge 21b is formed vertically such that the strength thereof does not become weak.

Next, with respect to the structure for which the anisotropic etching has been implemented, a photo resist pattern (not illustrated) is removed using oxygen plasma for example, so as to obtain the movable unit substrate 21 as shown in FIG. 7(3). It is for the following reason that a photo resist pattern (not illustrated) is removed using oxygen plasma. Namely, in the case where a photo resist pattern (not illustrated) is removed using a remover, or sulfuric acid and other acid solution, the remover or acid solution penetrates from a hole formed in the movable unit substrate 21 into a lower lying drive electrode unit 1 side so as to remove the drive electrode 12 and the insulating film 13. In the case of using oxygen plasma, however, such a danger does not exist.

Silicon dioxide (SiO₂) thin films and tantalum pentoxide (Ta₂O₅) thin films, of about 10-20 layers for example, are deposited alternately using a CVD device and a PVD device, on the substantially center part of top surface of the movable unit substrate 21, and thereby the highly reflective film 23 shown in FIG. 7(4) is formed. Through the manufacturing processes described above, the movable unit 2 shown in FIG. 1 is manufactured.

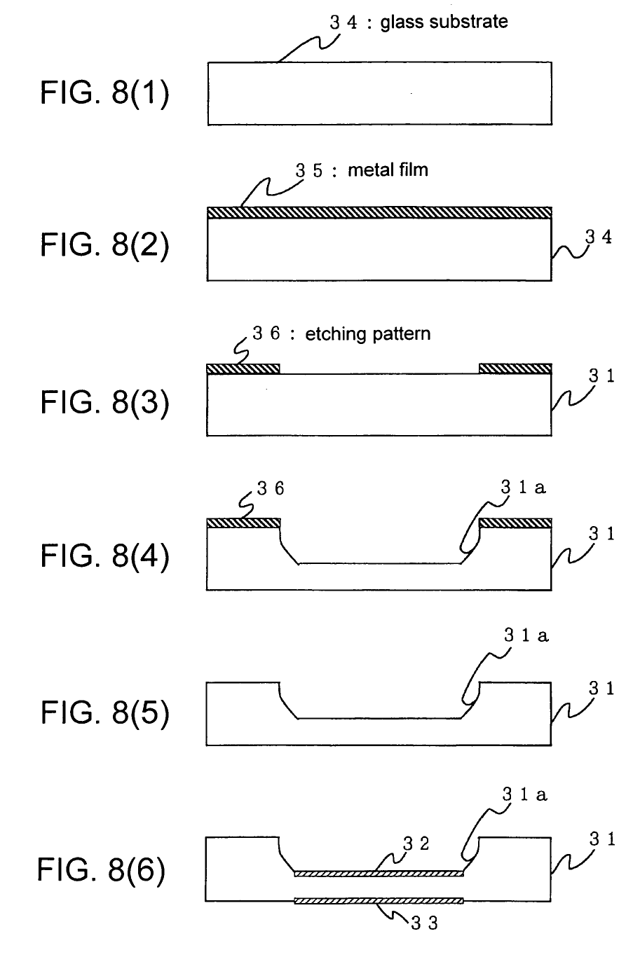

Then, in order to fabricate the optical gap unit 3, on a top surface of a glass substrate 34 (refer to FIG. 8(1)) composed of, for example, Corning #7740 of Pyrex (registered trademark)•glass, a metal film 35 such as gold (Au) and chromium (Cr) is formed by using a CVD device or PVD device as shown in FIG. 8(2). In the case of using gold (Au) as the metal film 35, the film thickness is 0.07 micrometers for example, in the case of using chromium (Cr) as the metal film 35, the film thickness is 0.03 micrometers for example.

Next, the entire top surface of the metal film 35 is coated with photo resist (not shown in the drawing), and then a photo resist pattern (not shown in the drawing) is formed by using the photolithography technique in order to later form a portion to become the concave portion 31a (refer to FIG. 1) of the glass substrate 31 out of the glass substrate 34. Next, by using a wet-etching technique, an unnecessary portion of the metal film 35 is removed with the metal etchant, and thereafter the photo resist pattern (not illustrated) is removed so as to obtain an etching pattern 36 shown in FIG. 8(3).

Next, by using a wet-etching technique, an unnecessary portion of the glass substrate 34 is removed with a hydrofluoric acid (HF) for example, so as to form the concave portion 31a shown in FIG. 8(4). Thereafter, by using a wet-etching technique, the etching pattern 36 is removed with the metal etchant, so as to obtain the glass substrate 31 in which the concave portion 31a is formed as shown in FIG. 8(5). The section of the glass substrate 31 becomes a substantially doubly-supported-beam shape because it is etched isotropically with a hydrofluoric acid (HF). Next, silicon dioxide (SiO₂) thin films and tantalum pentoxide (Ta₂O₅) thin films, of about 10-20 layers for example, are deposited alternately using a CVD device and a PVD device, on a top surface and lower surface at substantially the center of the concave portion 31a of the glass substrate 31, and thereby the highly reflective film 32 and the antireflection film 33 shown in FIG. 8(6) are formed. Through the manufacturing processes described above, the optical gap unit 3 shown in FIG. 1 is manufactured.

Next, the structure shown in FIG. 7(4) is joined to the optical gap unit 3 shown in FIG. 8(6) in such a manner that the highly reflective film 23 of a substantially disc shape faces the highly reflective film 32 of a substantially disc shape. For this joining, for example, anodic bonding, joining with an adhesive, surface activated bonding, or joining using low melting point glass is used. During this joining, the inside may be evacuated to a vacuum (vacuum sealing), or may be at suitable pressure (reduced pressure sealing). Through the manufacturing processes described above, the tunable optical filter shown in FIG. 1 is manufactured.

Next, the operation of a tunable optical filter having the above structure will be described referring to FIG. 1. Drive voltage is applied between the drive electrode 12 and the movable body 21a. This drive voltage is AC sinusoidal voltage of 60 Hz or pulse voltage for example, and is applied to the drive electrode 12 through a terminal and wiring (both not shown in the drawing) provided outside the glass substrate 11, while applied to the movable body 21a through the support portion 21c and the hinge 21b (refer to FIG. 2). Because of the potential difference by this drive voltage, electrostatic attraction between the drive electrode 12 and the movable body 21a is generated such that the movable body 21a is displaced toward a drive electrode 12 side. Namely, the electrostatic gap EG and the optical gap OG are changed. At this time, the movable body 21a is displaced elastically since the hinge 21b has elasticity.

A plurality (for example 60-100) of light components having infrared wavelengths enters the tunable optical filter from below at substantially the center of the drive electrode unit 1 (refer to an arrowhead of FIG. 1) in FIG. 1, so as to be transmitted through the glass substrate 11. The light components are hardly reflected because of the antireflection film 22 and are transmitted through the movable body 21a composed of silicon, so as to enter a space (reflection space) in which the highly reflective film 23 is formed below and the highly reflective film 32 is formed above. The light components entering the reflection space are repeatedly reflected between the highly reflective film 23 and the highly reflective film 32, and then are transmitted through the highly reflective film 32 and the glass substrate 31 finally, so as to be emitted from above the tunable optical filter. At this time, since the antireflection film 33 is formed on a top surface of the glass substrate 31, the light components are emitted while only being hardly reflected by an interface between the glass substrate 31 and air.

In the process in which light components are repeatedly reflected between the highly reflective film 32 (fixed mirror) and the highly reflected film 23 (movable mirror), light whose wavelength does not satisfy interference condition corresponding to the distance between the highly reflective film 32 and the highly reflective film 23 (optical gap OG) is abruptly attenuated, while only light whose wavelength satisfies this interference condition is left so as to be finally emitted from the tunable optical filter. This is the principle of a Fabry-Perot interferometer. Since light whose wavelength satisfies this interference condition is transmitted, the wavelength of a light to be transmitted can be selected if the movable body 21a is displaced and the optical gap OG is changed by changing drive voltage.

As described, the tunable optical filter according to the embodiment comprises the drive electrode unit 1 having the glass substrate 11, the movable body 2 composed of silicon (Si), and the optical gap unit 3 having the glass substrate 31, such that the electrostatic gap EG is formed precisely. In the case of using anodic bonding especially, the electrostatic gap EG is formed with extremely high precision. Accordingly, if a given drive voltage is applied between the movable body 21a and the drive electrode 12, electrostatic attraction that was expected by design for the drive voltage can be generated such that the movable body 21a can be displaced as designed. As a result, there is no need to control and set the drive voltage for extracting light having each wavelength, for each tunable optical filter. Thus the usability is excellent, and all light transmitted in an optical fiber having different wavelengths can be extracted.

Furthermore, in the tunable optical filter according to the embodiment, the electrostatic gap EG is formed without forming a sacrificial layer, while the insulating film 13 is formed on the drive electrode 12. Thus, even if the length of the electrostatic gap EG is set to be short, unlike in the case of the first and second related arts, sticking can be prevented both during manufacturing and while in use. As a result, process yield and endurance can be improved. In addition, in the tunable optical filter of the embodiment, a sacrificial layer is not formed in the manufacturing process. Thus there is no need to form a release hole for removing the sacrificial layer in the movable unit substrate 21 and so on such that the movable body 21a having the area as designed can be obtained. Accordingly, compared to the first and second related arts, the tunable optical filter can be driven with lower drive voltage such that power consumption can be reduced.

Moreover, in the tunable optical filter of the embodiment, since the concave portion 31a is formed by implementing glass etching of high precision for the glass substrate 34, and the optical gap unit 3 is joined to the movable unit 2, especially by anodic bonding, the optical gap OG is also formed precisely. The tunable optical filter therefore can be stably driven. In addition, in the tunable optical filter of the embodiment, the glass substrate 31, which is transparent, also serves as a sealing cap such that the operation of the tunable optical filter can be monitored.

Furthermore, in the tunable optical filter of the embodiment, since the movable body 2 is formed from the SOI substrate 24, the movable body 21a having a precise film thickness can be formed. In the case of using a commercially available substrate as the SOI substrate 24, since a surface of the active layer 27 has been already mirror-finished by the manufacturer, utilizing this enables the antireflection film 22 and the highly reflective film 23 of high precision to be formed.

Although the embodiment has been described referring to drawings above, the particular structure is not limited to the embodiment. Modification of design and so on without departing from the scope and spirit of the present invention is also included in the present invention.

For example, although the example in which the SOI substrate 24 is used to fabricate the movable unit 2 has been illustrated in the embodiment, the invention is not limited to this. Others may be used. For example, ann SOS (Silicon on Sapphire) substrate may be used. Otherwise, a substrate formed by attaching a top surface of a silicon substrate whose top surface has a silicon dioxide (SiO₂) film formed thereon and a top surface of other silicon substrate, may be used.

In addition, although the example in which both of the drive electrode unit 1 and the optical gap unit 3 are formed of a glass substrate has been illustrated in the embodiment, the invention is not limited to this. The drive electrode unit 1 and the optical gap unit 3 may be composed of, for example, materials through which a light of desired transmission wavelength band such as infrared, such as silicon, sapphire, and germanium for example.

Although the example in which the number of the hinges 21b is 4 (four) has been illustrated in the embodiment, the invention is not limited to this. The number of the hinges may be, for example, 3 (three), 5 (five), 6 (six), or more. In this case, the hinges are formed on the periphery of the movable body 21a so that the distance between the adjacent hinges is equal to each other. In addition, although the example in which the movable unit 2 is formed after the drive electrode unit 1 is joined to the structure shown in FIG. 5(2), and thereafter the structure shown in FIG. 7(4) is joined to the optical gap unit 3, has been illustrated in the embodiment, the invention is not limited to this. For example, the movable unit 2 may be formed after the optical gap unit 3 is joined to the SOI substrate 24 in which the highly reflective film 23 is formed on the active layer 27, and thereafter the drive electrode unit 1 may be joined thereto. As described, the tunable optical filter according to the embodiment has flexibility in its manufacturing process.

Although the example in which the insulating film 13 is formed on the drive electrode 12 has been illustrated in the embodiment, the invention is not limited to this. An insulating film may be formed on an area that is a lower surface of the movable body 21a and faces at least the drive electrode 12. As a method of forming this insulating layer, by using thermal oxidization in which silicon is heated under oxidizing atmosphere, and a TEOS (Tetra Ethyl Ortho Silicate)-CVD device for example, a silicon dioxide (SiO₂) film is formed. Meanwhile, both of the silicon dioxide (SiO₂) film and the tantalum pentoxide (Ta₂O₅) film that constitute the antireflection film 22 formed on an under surface at substantially the center of the movable body 21a, are also an insulator. The antireflection film 22 therefore may be formed on the entire lower surface of the movable body 21a so as to be also used as the insulating film. In this case, with respect to peripheral part of a lower surface of the movable body 21a, there is no need to form a number of layers that would be sufficient to function as the antireflection film 22. Only layers in a number sufficient to function as an insulating film may be formed. Moreover, both the insulating film 13 and an insulating film formed on a lower surface of the movable body 21a may be formed. As described, if the antireflection film 22 is also used as an insulating film, the same advantageous effect as that of the above embodiment can be obtained through less manufacturing processes such that a tunable optical filter can be made at low cost. Furthermore, although the example in which the highly reflective film 32 is formed on the entire lower surface of the optical gap unit 3 has been illustrated in the embodiment, the invention is not limited to this. The highly reflective film 32 may be formed only on an area that faces the highly reflective film 23 of the lower surface of the optical gap unit 3.

1. A tunable optical filter comprising:
a movable unit supporting a movable body that moves up and down freely, a movable mirror being formed on one surface of the movable body;
a drive electrode unit in which a drive electrode facing the movable body with a given electrostatic gap therebetween is formed; and
an optical gap unit in which a fixed mirror facing the movable mirror with a given optical gap therebetween is formed, the optical gap unit, the drive electrode unit, and the movable unit being joined to each other.

2. The tunable optical filter according to claim 1 wherein an insulating film is formed on at least one of an area of the drive electrode that faces the movable body, and an area of the movable body that faces the drive electrode.

3. The tunable optical filter according to claim 2 wherein an antireflection film formed on the other surface of the movable body is also used as the insulating film.

4. The tunable optical filter according to claim 1, wherein:
the movable unit is composed of silicon;
at least one of the drive electrode unit and the optical gap unit are composed of glass containing an alkali metal; and
at least one of the joining between the movable unit and the drive electrode unit, and the joining between the movable unit and the optical gap unit is implemented by anodic bonding.

5. A method of manufacturing a tunable optical filter comprising:
(a) forming a first concave portion in a first substrate, and thereafter forming a drive electrode on the first concave portion so as to form a drive electrode unit;
(b) forming a second concave portion in a second substrate, and thereafter forming a fixed mirror on the second concave portion so as to form an optical gap unit;
(c) joining a third substrate on which an active layer having electrical conductivity, an insulating layer, and a base layer are sequentially deposited, to the drive electrode unit such that the drive electrode faces the active layer, and then removing the base layer and the insulating layer sequentially and forming a movable body in the active layer, and thereafter forming a movable mirror on the movable body; and
(d) joining a structure that has been manufactured in step (c) to the optical gap unit such that the movable mirror faces the fixed mirror.

6. A method of manufacturing a tunable optical filter comprising:
(a) forming a first concave portion in a first substrate, and thereafter forming a drive electrode on the first concave portion so as to form a drive electrode unit;
(b) forming a second concave portion in a second substrate, and thereafter forming a fixed mirror on the second concave portion so as to form an optical gap unit;
(c) joining a third substrate on which an active layer having electrical conductivity on which a movable mirror is formed, an insulating layer, and a base layer are sequentially deposited, to the optical gap unit such that the movable mirror faces the fixed mirror, and then removing the base layer and the insulating layer sequentially and forming a movable body in the active layer; and
(d) joining a structure that has been manufactured in step (c), to the drive electrode unit such that the movable body faces the drive electrode.

7. The method of manufacturing a tunable optical filter according to claim 5 wherein an insulating film is formed on an area to face the movable body of the drive electrode, in step (a).

8. The method of manufacturing a tunable optical filter according to claim 5 wherein the joining is implemented such that the drive electrode faces the active layer after an insulating film is formed on an area to face the drive electrode as the movable body of the active layer, in step (c).

9. The method of manufacturing a tunable optical filter according to claim 8 wherein the insulating film and an antireflection film are formed on an area to become the movable body of the active layer, in step (c).

10. The method of manufacturing a tunable optical filter according to claim 6 wherein an insulating film is formed on an area to become the movable body and face the drive electrode before the movable body is formed, in step (c).

11. The method of manufacturing a tunable optical filter according to claim 10 wherein the insulating film and an antireflection film are formed on an area to become the movable body before the movable body is formed, in step (c).

12. The method of manufacturing a tunable optical filter according to claim 5, wherein:
the active layer is composed of silicon;
at least one of the first substrate and the second substrate are composed of glass containing an alkali metal; and
the joining is implemented by anodic bonding in at least one of step (c) and step (d).

13. The method of manufacturing a tunable optical filter according to claim 6 wherein an insulating film is formed on an area to face the movable body of the drive electrode, in step (a).

14. The method of manufacturing a tunable optical filter according to claim 13 wherein the joining is implemented such that the drive electrode faces the active layer after an insulating film is formed on an area to face the drive electrode as the movable body of the active layer, in step (c).

15. The method of manufacturing a tunable optical filter according to claim 14 wherein the insulating film and an antireflection film are formed on an area to become the movable body of the active layer, in step (c).
